(19) United States
(12) Patent Application Publication
(10) Pub. No.: US 2025/0220093 A1
(43) Pub. Date: Jul. 3, 2025

(54) MANAGING NETWORK LAYERS

(71) Applicant: T-MOBILE INNOVATIONS LLC, Overland Park, KS (US)

(72) Inventors: Roopesh Kumar POLAGANGA, Bothell, WA (US); Madhav Ram NUSETTY, Snohomish, WA (US); Satish Subramanya PACHALLA, Sammamish, WA (US)

(21) Appl. No.: 18/398,721

(22) Filed: Dec. 28, 2023

(51) Int. Cl. H04L 69/321; H04W 36/24

(52) U.S. Cl. CPC H04L 69/321; H04W 36/24

(57) ABSTRACT

Systems and methods are provided for managing network layers. Network providers often define their network with pre-defined network layer priorities depending on their spectrum holdings (e.g., bandwidth) and capability of devices. User device performance metrics are valuable data points that allow for intelligent traffic steering and network layer management based on device-specific performance related to specific network layers. Location session records (LSR) data provides detailed inputs for sessions for each user device in a network. This historical data can be utilized to identify performance issues on certain network layers for specific user devices and proactively steer the devices to other network layers to improve performance.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for managing network layers. More particularly, in aspects set forth herein, systems and methods enable intelligent traffic steering based on device-specific performance on particular network layers. Device-specific information including a device type, a software version, and the like can be analyzed with historical performance data to predict potential performance issues on a device-specific level and dynamically re-prioritize network layers such that any layers associated with performance issues are de-prioritized lower in the prioritization.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a flow diagram of a method for managing network layers, in accordance with aspects herein;

FIG. 3 depicts a flow diagram of a method for managing network layers, in accordance with aspects herein;

FIG. 4 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
LSR Location Session Records
MIMO Multiple Input Multiple Output
MD Mobile Device
PC Personal Computer
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

The present disclosure is directed to managing network layers. Network providers often define their network with pre-defined network layer priorities depending on their spectrum holdings (e.g., bandwidth) and capability of devices. Device performance metrics are valuable data points that are not currently used that can allow for intelligent traffic steering and network layer management based on device-specific performance related to specific network layers. Location session records (LSR) data provides detailed inputs for sessions for each user device in a network. This historical data can be utilized to identify performance issues on certain network layers for specific user devices and proactively steer the devices to other network layers to improve performance.

Accordingly, a first aspect of the present disclosure is directed to a system for managing network layers. The system comprises one or more processors and one or more computer-readable media storing computer-usable instructions that, when executed by the one or more processors, cause the one or more processors to: identify that a first device is experiencing a change in one or more device performance metrics; associate the change in the one or more device performance metrics with a first network layer; and re-prioritize one or more available network layers for the first device, wherein the first network layer is given a lowest priority value.

A second aspect of the present disclosure is directed to a method for managing network layers. The method starts by identifying that a first device is experiencing a change in one or more device performance metrics. Device performance metrics can include a number of dropped sessions (e.g., dropped calls, dropped data streams, etc.), a failure to initiate/establish a network session, a decrease in throughput, and the like. The change in the one or more device performance metrics is associated with a first network layer and one or more available network layers are re-prioritized for the first device. The first network layer is given a lowest priority value due to the change in the one or more device performance metrics.

Another aspect of the present disclosure is directed to a method for managing network layers. The method comprises identifying an upcoming first period of time where a first device has experienced a change in one or more device performance metrics on a first network layer based on historical data. For instance, a device may historically show difficult on the first network layer between 8:00 a.m. and 9:00 a.m. (e.g., a morning commute) such that the present method can identify that time period is approaching and that difficulties may arise. Prior to the upcoming first period of time, a network layer prioritization can be re-prioritized to generate an updated network layer prioritization. The first network layer is assigned a lowest priority value since historical data indicates a change in performance during the first period of time on the first network layer. The updated network layer prioritization is communicated to the first device.

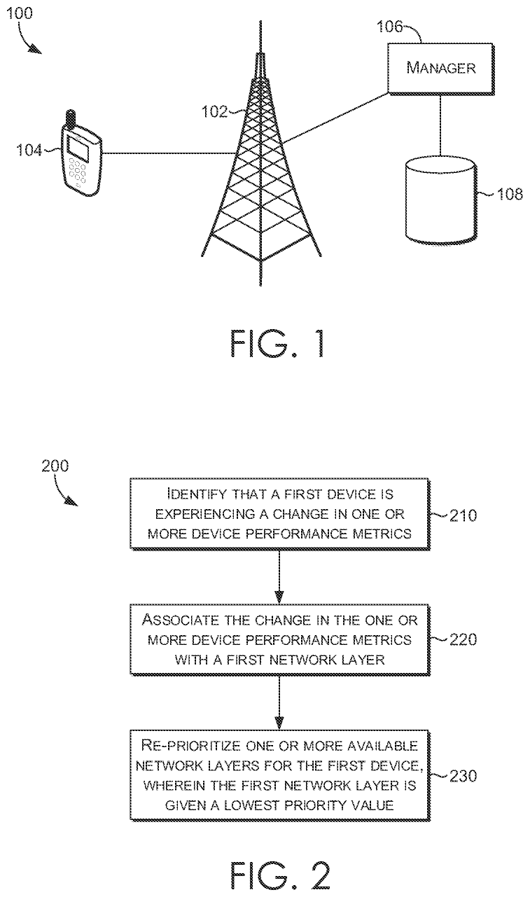

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

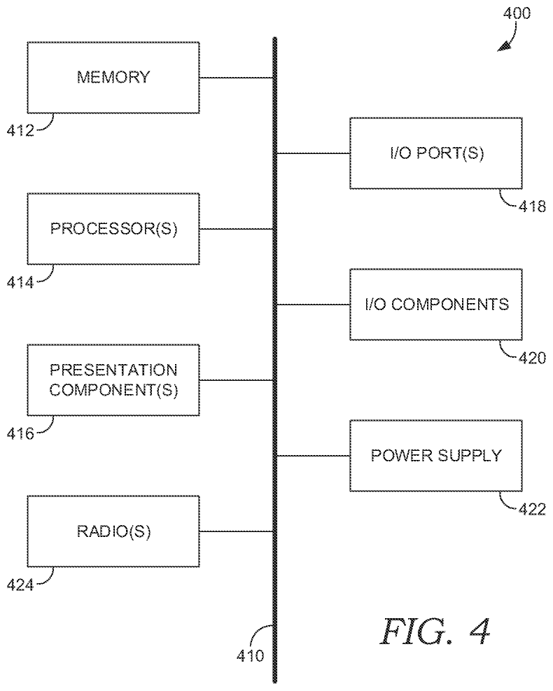

A network cell may comprise a base station to facilitate wireless communication between a communications device within the network cell, such as communications device 400 described with respect to FIG. 4, and a network. As shown in FIG. 1, communications device may be UE 104. In the network environment 100, UE 104 may communicate with other devices, such as mobile devices, servers, etc. The UE 104 may take on a variety of forms, such as a personal computer, a laptop computer, a tablet, a netbook, a mobile phone, a Smart phone, a personal digital assistant, or any other device capable of communicating with other devices. For example, the UE 104 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 104 comprises a wireless or mobile device with which a wireless telecommunication network(s) can be utilized for communication (e.g., voice and/or data communication). In this regard, the UE 104 can be any mobile computing device that communicates by way of, for example, a 5G network.

The UE 104 may utilize a network to communicate with other computing devices (e.g., mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, the network is associated with a telecommunications provider that provides services to user devices, such as UE 104. For example, the network may provide voice services to user devices or corresponding users that are registered or subscribed to utilize the services provided by a telecommunications provider.

The environment 100 further comprises a base station 102, a manager 106, and a data store 108. The manager 106 may be a centralized server accessible to many base stations 102/eNodeB/gNodeB or may be located at each eNodeB/gNodeB. As described herein, the base station 102 can dynamically and intelligently steer traffic based on one or more device performance metrics. Network providers generally prioritize layers based on capabilities of devices and network bandwidth. Device capabilities vary across devices based on release dates, manufacturers, device model types, etc. For example, devices that have been released recently (e.g., in the last year) that are sophisticated smart phones will likely have the capability to support mmWave technology. However, a device that is, for example, eight years old, likely won't have that capability. Device capabilities are currently used for network layer prioritization but device-specific performance is not currently utilized.

Additionally, networks often times assign devices to layers based on available bandwidth. The N41 layer, for instance, is a high capacity layer with large amounts of bandwidth. Network providers may attempt to load the N41 layer with an abundance of devices since it has the capability to handle it, regardless of whether a particular device performs well on that particular layer. Thus, the N41 network layer is often times assigned a highest priority value in a network layer prioritization that is communicated to user devices.

Location Session Records (LSR) data can be used to identify a change in one or more performance metrics compared to a baseline performance metric. The one or more device performance metrics can be obtained/accessed/received by the base station 102 from the manager 106, the data store 108, or a combination thereof. A change, as used herein, can refer to an increase or a decrease in at least one of the one or more performance metrics. As described herein, the change can be qualified as a negative change if there is a reduction in performance, which may be caused by an increase or decrease in the specific performance metric evaluated. For instance, an increase in dropped calls would be a negative change, but negative change as it relates to throughput would be a decrease in throughput.

The LSR data can include a device type, a software version, a manufacturer, a release data of the device, and the like. A device release date, for example, can be associated with particular hardware/structure related to a device that may limit device capabilities. The additional information may also prove to be a common link among devices experiencing changes in performance metrics. For instance, some devices that share a model type may experience changes in their performance metrics, while others of the same model type do not. Upon inspection, the system 100 may identify that the devices experiencing changes were pushed a software version upgrade while those that are not experiencing issues did not receive the software version upgrade.

The changes in one or more device performance metrics may be classified in one or more categories. As described herein, device performance metrics include metrics that measure accessibility, performance, and retainability. Accessibility performance metrics, as used herein, generally describe a device's ability to access a network to establish/initiate a session on the network. Access failures result in an inability to initiate a network session. An increase in access failures would be identified as a change (e.g., a negative change) in device performance metrics. Performance metrics (or degradation metrics), as used herein, generally describe a throughput compared to a historical baseline. Thus, a decrease in throughput would be identified as a change (e.g., a negative change) in device performance metrics. Software version upgrades or large events (e.g., concerts, stadium events, etc.) can be a common cause for a reduction in throughput. Retainability performance metrics, as used herein, generally refers to a drop rate compared to a historical baseline. The drop rate can be with respect to voice, data, or both. An increase in the drop rate would be identified as a change (e.g., a negative change) in device performance metrics.

A change in any one of the above-described one or more device performance metrics can trigger the gNodeB to dynamically adjust network layer assignments. The one or more device performance metrics can be collected at a predetermined time interval. In embodiments, the predetermined time interval is every 15 minutes. In additional embodiments, the predetermined time interval is greater than 15 minutes.

Once the change is identified, a current network layer is identified and associated with the change in the one or more device performance metrics. For instance, if device 1 is on network layer n25 and a change in the one or more device performance metrics is identified (when compared to the historical baseline for device 1), then network layer n25 is associated with the LSR data for device 1 as being inferior. Specifically, the network n25 may be associated with a specific device type as being inferior or potentially with a specific software version for a device type. The inferior layer refers to a layer that is associated with a change in one or more device performance metrics for a device. The inferior layer may be “flagged” as inferior for a site list. The site list can include all network layers for a site and all devices that are currently being served for a site.

When marked as inferior, a re-prioritization of network layers is initiated. Generally, gNodeB's will have a network layer prioritization that is distributed to each device it serves. This network layer prioritization will include each network layer available at the gNodeB and a respective priority for each layer, customized for each device based on its known capabilities. A re-prioritized or updated network layer prioritization is generated when an inferior network layer is flagged/identified for a device; thus, triggering a new network layer prioritization for that device to be created. The updated network layer prioritization will associate/assign a lowest priority to the network layer that is associated with the change in the one or more device performance metrics. This is intended to prevent the device to connect on the network layer associated with decreased performance.

The updated network layer prioritization is communicated to any impacted user devices. If the user device is currently connected to a network layer, the updated network layer prioritization is communicated to the user device along with, or included therein, an instruction to handover to a network layer other than the current network layer (i.e., the current network layer associated with a negative change in the one or more device performance metrics). The user device can utilize the updated network layer prioritization to identify the network layer having the highest priority value and handoff to that network layer, thereby disconnecting from the current network layer associated with the decreased performance. If the user device is not currently connected to a network layer (i.e., an idle device), the updated network layer prioritization is communicated to the user device along with, or included therein, an instruction to reconnect to a network layer other than the network layer associated with the decreased performance when it initiates a new session/re-connects to the network. Thus, when the idle device attempts to re-connect to the network, the updated network layer prioritization will be the available prioritization listing and the idle device will attempt to network layers according to the order of prioritization listed therein.

The updated network layer prioritization can be communicated to devices and remain in effect without a stop time (e.g., indefinitely). Alternatively, updated network layer prioritizations can be associated with a timer indicating an expiration on the updated network layer prioritization. Upon expiration, the updated network layer prioritization may be replaced with the original network layer prioritization. Alternatively, upon expiration, the gNodeB can evaluate the conditions to determine whether to extend the timer and keep the updated network layer prioritization in effect, or if the updated network layer prioritization should be replaced with the original network layer prioritization.

An example prioritization list is provided below where one or more devices experience performance issues on the N25-1C layer. As shown, the N25-1C layer is de-prioritized and given a lowest priority value.

| | |
|---|---|
| Priority for All other Devices | Priority for Impacted Devices |

| Layer | Priority | Priority | Layer |
|---|---|---|---|
| N41 | 7.6 | 7.6 | N41 |
| N66 | 7.4 | 7.4 | N66 |
| N25-1C | 7.2 | 7.2 | LTE |
| LTE | 5 | 5 | N71 |
| N71 | 3 | 3 | N25-2C |
| N25-2C | 1 | 1 | N25-1C |

The gNodeB can continuously or periodically monitor a load on the network layers. While proactively steering devices away from decreased performance, the gNodeB also needs to balance loads of network layers so a network layer is not overloaded or under-utilized while other layers experience heavy loads.

In addition to providing improved device performance, the present disclosure provides improved device sustainability, as well. The performance metrics described herein as negative changes (e.g., dropped sessions, dropped calls, reconnecting to the network, etc.) all cause increase signaling, increase uplink, and the like. This is extremely hard on device batteries. Proactively steering traffic away from this outcome provides better device performance, increase network efficiency, and helps with device-specific battery savings.

Turning to FIG. 2, a flow diagram 200 is provided illustrating a flow to manage network layers. Initially, at block 210, a first device is identified as experiencing a change in one or more device performance metrics. A change in one or more device performance metrics can be an increase or a decrease, depending on the specific performance metric that is evaluated. For instance, an increase in a dropped call rate would be a negative change as well as an increase in failures to connect to the network. However, a decrease in throughput would be a negative change in performance metrics. Thus, the present system monitors for negative changes in order to optimize performance and avoid layers that cause negative changes. At block 220, the change in the one or more device performance metrics is associated with a first network layer where the change(s) were observed. At block 230, one or more available network layers are re-prioritized for the first device. The first network layer is given a lowest priority value such that it is a last option for connections for the first device. Put simply, the first network layer is associated with negative changes in device performance metrics for the first device so the system wants to avoid the first device connecting on the first network layer. Thus, the system prioritizes other available network layers ahead of the first network layer by assigning the first network layer a lowest priority value and other available network layers priority values higher than the lowest priority value.

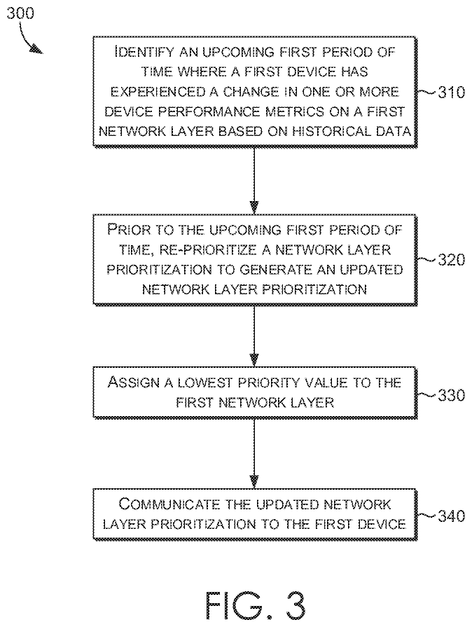

Referring to FIG. 3, a flow diagram 300 is provided illustrating a flow to manage network layers. Initially, at block 310, an upcoming first period of time is identified where a first device has experienced a change in one or more device performance metrics on a first network layer based on historical data. Historical performance data is available, via the manager 106 and/or data store 108 to evaluate in order to identify time periods where a device has a negative change in one or more device performance metrics. As previously mentioned, a device may have a change in one or more device performance metrics on a first network layer between the hours of 8 am and 9 am (e.g., a morning commute). Prior to the upcoming first period of time, a network layer prioritization is re-prioritized to generate an updated network layer prioritization at block 320. At block 330, a lowest priority value is assigned to the first network layer and the updated network layer prioritization is communicated to the first device at block 340.

Referring to FIG. 4, a block diagram of an exemplary computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. It should be noted that although some components in FIG. 4 are shown in the singular, they may be plural. For example, the computing device 400 might include multiple processors or multiple radios. In aspects, the computing device 400 may be a UE/WCD, or other user device, capable of two-way wireless communications with an access point. Some non-limiting examples of the computing device 400 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 410 that directly or indirectly couples various components together, including memory 412, processor(s) 414, presentation component(s) 416 (if applicable), radio(s) 424, input/output (I/O) port(s) 418, input/output (I/O) component(s) 420, and power supply(s) 422. Although the components of FIG. 4 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 412 may take the form of memory components described herein. Thus, further elaboration will not be provided here, but it should be noted that memory 412 may include any type of tangible medium that is capable of storing information, such as a database. A database may be any collection of records, data, and/or information. In one embodiment, memory 412 may include a set of embodied computer-executable instructions that, when executed, facilitate various functions or elements disclosed herein. These embodied instructions will variously be referred to as “instructions” or an “application” for short.

Processor 414 may actually be multiple processors that receive instructions and process them accordingly. Presentation component 416 may include a display, a speaker, and/or other components that may present information (e.g., a display, a screen, a lamp (LED), a graphical user interface (GUI), and/or even lighted keyboards) through visual, auditory, and/or other tactile cues.

Radio 424 represents a radio that facilitates communication with a wireless telecommunications network. Illustrative wireless telecommunications technologies include CDMA, GPRS, TDMA, GSM, and the like. Radio 424 might additionally or alternatively facilitate other types of wireless communications including Wi-Fi, WiMAX, LTE, 3G, 4G, LTE, mMIMO/5G, NR, VOLTE, or other VOIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 418 may take a variety of forms. Exemplary I/O ports may include a USB jack, a stereo jack, an infrared port, a firewire port, other proprietary communications ports, and the like. Input/output (I/O) components 420 may comprise keyboards, microphones, speakers, touchscreens, and/or any other item usable to directly or indirectly input data into the computing device 400.

Power supply 422 may include batteries, fuel cells, and/or any other component that may act as a power source to supply power to the computing device 400 or to other network components, including through one or more electrical connections or couplings. Power supply 422 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for managing network layers, the system comprising:
one or more processors; and
one or more computer-readable media storing computer-usable instructions that, when executed by the one or more processors, cause the one or more processors to:
identify that a first device is experiencing a change in one or more device performance metrics;
associate the change in the one or more device performance metrics with a first network layer; and
re-prioritize one or more available network layers for the first device, wherein the first network layer is given a lowest priority value.

2. The system of claim 1, wherein the one or more performance metrics includes an increase in a number of dropped sessions.

3. The system of claim 1, wherein the one or more performance metrics includes a failed attempt to establish a network session.

4. The system of claim 1, wherein the one or more performance metrics includes a decrease in throughput.

5. The system of claim 1, wherein the one or more processors is further configured to communicate an instruction to handover the first device to a network layer different than the first network layer.

6. The system of claim 1, wherein the one or more processors is further configured to flag the first network layer as an inferior layer.

7. The system of claim 6, wherein the one or more processors is further configured to associate the first network layer with the lowest priority value for any user device at a same cell site as the first device and having at least a same device type and same software version as the first device.

8. A method for managing network layers, the method comprising:
identifying that a first device is experiencing a change in one or more device performance metrics;
associating the change in the one or more device performance metrics with a first network layer; and
re-prioritizing one or more available network layers for the first device, wherein the first network layer is given a lowest priority value.

9. The method of claim 8, further comprising communicating an instruction to the first device to handover to a second network layer different than the first network layer and having a higher priority value than the first network layer.

10. The method of claim 8, further comprising communicating an instruction to an idle device having a same device type as the first device to reconnect to a second network layer different than the first network layer and having a higher priority value than the first network layer.

11. The method of claim 8, further comprising flagging the first network layer as an inferior layer.

12. The method of claim 11, further comprising associating the first network layer with the lowest priority value for any user device at a same cell site as the first device and having at least a same device type and same software version as the first device.

13. The method of claim 8, wherein the one or more performance metrics includes an increase in a number of dropped sessions.

14. The method of claim 8, wherein the one or more performance metrics includes one or more of a failed attempt to establish a network session and a decrease in throughput.

15. A method for managing network layers, the method comprising:
identifying an upcoming first period of time where a first device has experienced a change in one or more device performance metrics on a first network layer based on historical data;
prior to the upcoming first period of time, re-prioritizing a network layer prioritization to generate an updated network layer prioritization;
assigning a lowest priority value to the first network layer; and
communicating the updated network layer prioritization to the first device.

16. The method of claim 15, further comprising associating the updated network layer prioritization with a timer.

17. The method of claim 16, wherein upon expiration of the timer, the updated network layer prioritization expires.

18. The method of claim 15, the one or more device performance metrics comprises one or more of an increase in a number of dropped sessions, a failed attempt to establish a network session, and a decrease in throughput.

19. The method of claim 15, further comprising monitoring a load for each network layer.

20. The method of claim 19, further comprising adjusting the updated network layer prioritization when a network layer is identified as having a load exceeding a predetermined load threshold.
